(19) United States
(12) Patent Application Publication
(10) Pub. No.: US 2025/0055109 A1
(43) Pub. Date: Feb. 13, 2025

(54) SWAPPABLE MODULAR BATTERY AND ELECTRONIC SPEED CONTROLLER SYSTEM FOR ELECTRIC VEHICLES

(71) Applicant: Creative Power IP Corp, Woodbury, NY (US)

(72) Inventor: Jared Ebersole, Catawissa, PA (US)

(21) Appl. No.: 18/232,203

(22) Filed: Aug. 9, 2023

(51) Int. Cl. H01M 50/244; B60L 53/80; B60S 5/06; H01M 10/42; H01M 50/249; H01M 50/264

(52) U.S. Cl. CPC H01M 50/244; B60L 53/80; B60S 5/06; H01M 10/425; H01M 50/249; H01M 50/264; H01M 2220/20

(57) ABSTRACT

A swappable modular battery and electronic speed controller system for electric vehicles is provided. The system includes a plurality of modular rail elements configured to attach to one or more electric vehicles. A desired number of modular battery units are configured to slide into and connect with at least one modular rail element of the plurality of the modular rail elements. A modular electronic speed controller (ESC) is configured to slide into and connect with at least one modular rail element of the plurality of the modular rail elements. The modular battery unit and the ESC are removable from the modular rail elements, allowing for transfer between the electric vehicles.

### CROSS-REFERENCE TO RELATED APPLICATIONS

N/A

### BACKGROUND OF THE INVENTION

### 1. Field of the Invention

The present invention relates to modular systems but more particularly a swappable modular battery and electronic speed controller system for electric vehicles.

### 2. Description of Related Art

Electric vehicles are gaining popularity, and now most transportation vehicle types may be configured for electric use, including but not limited to, scooters, bikes, gokarts, skateboards, boats, robots, etc. The appeal of these electric vehicles lies not only in their environmental friendliness but also in their efficiency, quiet operation, and the convenience of home charging.

However, the transition to electric power is not without its challenges. One of the primary barriers to widespread adoption is the high cost associated with electric vehicle components, particularly the battery and the electronic speed controller (ESC). The battery, which provides the power for the vehicle, and the ESC, which serves as the vehicle's brain by controlling the distribution of power to the motor, represent significant investments. This is true whether one is purchasing a new electric vehicle or retrofitting a traditional vehicle for electric operation.

Further, the current design of electric vehicles does not lend itself to flexibility or customization. Batteries and ESCs are typically integrated into the vehicle's design in a fixed manner, making it difficult to swap these components between different vehicles or adjust the vehicle's range and power according to the user's needs. Consequently, the invention provides a swappable modular battery and electronic speed controller system for electric vehicles, which enables the swapping of components between various electric vehicles.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is a particular object of the present invention to provide a swappable modular battery and electronic speed controller system for electric vehicles designed to reduce costs, increase flexibility, and make electric power more accessible for a wide range of vehicles. It is another object of the present invention to create a system where the battery and ESC are modular and can be quickly connected or disconnected, such that users can easily transfer these components between different vehicles. This not only allows users to save money by using the same battery and ESC for multiple vehicles, but it also enables them to customize their vehicle's range and power by adding or removing battery modules as needed.

In order to do so, a swappable modular battery and electronic speed controller system for electric vehicles is provided, comprising a plurality of modular rail elements configured to attach to an electric vehicle having a motor; at least one modular battery unit configured to slide into and connect with at least one modular rail element of the plurality of the modular rail elements; a modular electronic speed controller configured to slide into and connect with at least one modular rail element of the plurality of the modular rail elements, wherein the modular electronic speed controller is configured to regulate power drawn from the at least one modular battery unit and direct it to the motor of the electric vehicle; and, wherein the at least one modular battery unit and the modular electronic speed controller are removable from the plurality of modular rail elements, allowing for transfer between different electric vehicles.

In one embodiment, the plurality of modular rail elements are configured to stack horizontally adjacent to one another. In one embodiment, each modular rail element comprises attachment elements and the at least one modular battery unit and the modular electronic speed controller comprise attachment guides configured to slide under the attachment elements of each modular rail element of the plurality of modular rail elements. In another embodiment, the at least one modular battery unit and the modular electronic speed controller comprise a housing configured to house electronic components facilitating the electrical connection of each modular component. In yet another embodiment, the electronic components comprises electrical wires and terminal connections, wherein the terminal connections enable the electrical connection between adjacent modular units. In one embodiment, the at least one modular battery unit is a rechargeable battery suitable for powering various electric vehicles. In one embodiment, the range of the electric vehicle can be adjusted by varying the number of modular battery units. In one embodiment, the at least one modular battery unit, and the modular electronic speed controller are configured for quick connect and disconnect, facilitating easy swapping of units. In one embodiment, the at least one modular battery unit, the modular electronic speed controller, and the plurality of modular rail elements are constructed of materials selected from the group consisting of plastics, metals, and composite materials.

In another aspect of the invention, a swappable modular battery and electronic speed controller system for electric vehicles is provided, comprising a plurality of modular rail elements configured to attach to one or more electric vehicles, wherein each modular rail element of the plurality of the modular rail elements is configured to stack horizontally adjacent to one another; at least one rectangular modular battery unit configured to slide into and connect with at least one modular rail element of the plurality of the modular rail elements; a rectangular modular electronic speed controller configured to slide into and connect with at least one modular rail element of the plurality of the modular rail elements, wherein the modular electronic speed controller is configured to regulate power drawn from the at least one modular battery unit and direct it to a motor of the one or more electric vehicle; wherein at least one of the modular battery units and the modular electronic speed controller are removable from the plurality of modular rail elements, allowing for transfer between each of the one or more electric vehicles; and, wherein the at least one modular battery unit, and the modular electronic speed controller are configured for quick connect and disconnect, facilitating easy swapping of modular units between each of the one or more electric vehicles.

In one embodiment, an attachment mechanism is provided, and is configured to secure the at least one modular battery unit and the modular electronic speed controller to the plurality of modular rail elements. In another embodiment, a securement element is provided and positioned at an end of each modular rail element, configured to prevent the at least one modular battery unit and the modular electronic speed controller from sliding off the modular rail elements. In one embodiment, each modular rail element is configured to nest within an adjacent modular rail element, creating a seamless singular rail element when stacked horizontally. In another embodiment, each modular rail element comprises a base having a cavity and an expanded section, the expanded section configured to fit snugly within the cavity of an adjacent modular rail element, facilitating the nesting of adjacent units. In yet another embodiment, the attachment mechanism comprises a slide fit attachment mechanism that provides a frictional engagement between the at least one modular battery unit, the modular electronic speed controller, and the plurality of modular rail elements. In another aspect of the invention, a swappable modular battery and electronic speed controller system for electric vehicles is provided, comprising a plurality of modular rail elements configured to attach to one or more electric vehicles, wherein each modular rail element of the plurality of the modular rail elements is configured to nest adjacent to one another creating a singular seamless rail element; at least two rectangular shaped modular battery units configured to slide into the singular seamless rail element; a rectangular-shaped modular electronic speed controller configured to slide into the singular seamless rail element, wherein the modular electronic speed controller is configured to regulate power drawn from the at least one modular battery unit and direct it to a motor of an electric vehicle of the one or more electric vehicles; wherein at least one of the at least two modular battery units and the modular electronic speed controller are removable from the singular seamless rail element, allowing for transfer between each electric vehicle of the one or more electric vehicles and, wherein the at least two modular battery units, and the modular electronic speed controller are configured for quick connect and disconnect, facilitating easy swapping of modular units between the one or more electric vehicles.

The foregoing has outlined rather broadly the more pertinent and important features of the present invention so that the detailed description of the invention that follows may be better understood and so that the present contribution to the art can be more fully appreciated. Additional features of the invention, which will be described hereinafter, form the subject of the claims of the invention. It should be appreciated by those skilled in the art that the conception and the disclosed specific methods and structures may be readily utilized as a basis for modifying or designing other structures for carrying out the same purposes of the present invention. It should be realized by those skilled in the art that such equivalent structures do not depart from the spirit and scope of the invention as set forth in the appended claims.

### BRIEF DESCRIPTION OF THE DRAWINGS

Other features and advantages of the present invention will become apparent when the following detailed description is read in conjunction with the accompanying drawings, in which:

FIG. 1 is a perspective view of a swappable modular battery and electronic speed controller system for electric vehicles according to an embodiment of the present invention.

FIG. 2 is an exploded view of the swappable modular battery and electronic speed controller system for electric vehicles according to an embodiment of the present invention.

FIG. 3 is a top view of the swappable modular battery and electronic speed controller system for electric vehicles according to an embodiment of the present invention.

FIG. 4 is a rear view of the swappable modular battery and electronic speed controller system for electric vehicles according to an embodiment of the present invention.

FIG. 5 is a rear view of the swappable modular battery and electronic speed controller system for electric vehicles of FIG. 4 with several modular rail elements removed according to an embodiment of the present invention.

FIG. 6 is a perspective view of a swappable modular battery and electronic speed controller system for electric vehicles with larger modular battery units according to an embodiment of the present invention.

FIG. 7 is a schematic representation of the swappable modular battery and electronic speed controller system for electric vehicles within a larger electric vehicle system of one or more electric vehicles according to an embodiment of the present invention.

FIG. 8 is a side perspective view of a modular unit illustrating a connection mechanism according to an embodiment of the present invention.

FIG. 9 is a perspective view of the securement element according to an embodiment of the present invention.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a swappable modular battery and electronic speed controller system for electric vehicles.

It is to be understood that the terminology used herein is for the purpose of describing particular embodiments only and is not intended to be limiting. The terms “a” or “an,” as used herein, are defined to mean “at least one.” The term “plurality,” as used herein, is defined as two or more. The term “another,” as used herein, is defined as at least a second or more. The terms “including” and/or “having,” as used herein, are defined as comprising (i.e., open language). The term “providing” is defined herein in its broadest sense, e.g., bringing/coming into physical existence, making available, and/or supplying to someone or something, in whole or in multiple parts at once or over a period of time. These terms generally refer to a range of numbers that one of skill in the art would consider equivalent to the recited values (i.e., having the same function or result). In many instances these terms may include numbers that are rounded to the nearest significant figure.

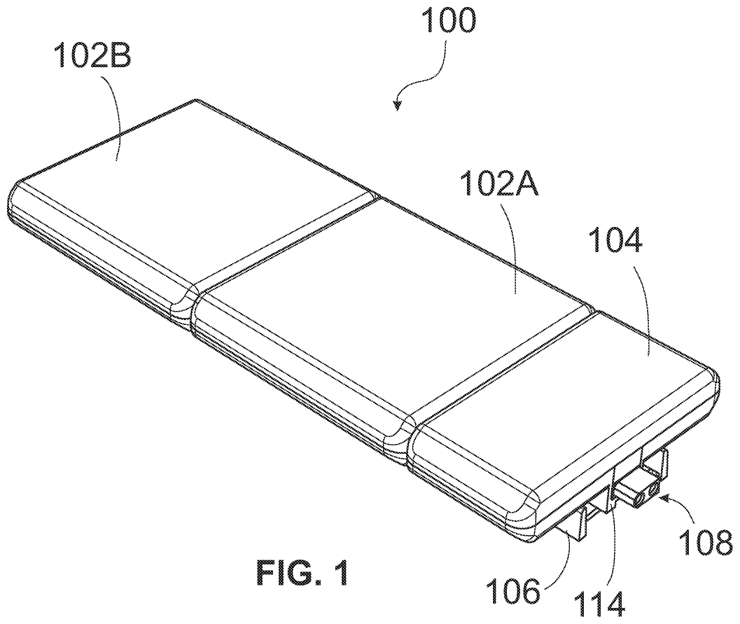

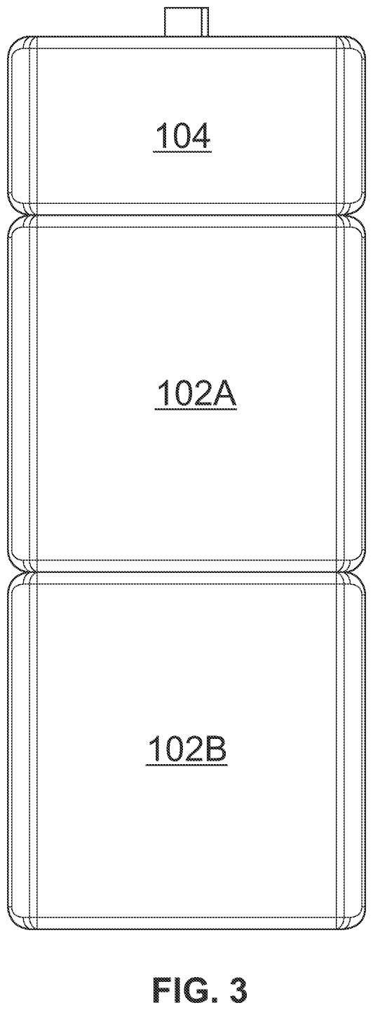

Referring now to FIGS. 1-4, various views of the swappable modular battery and electronic speed controller system for electric vehicles 100 are illustrated. In some embodiments, the swappable modular battery and electronic speed controller system for electric vehicles 100 comprises a number of modular battery units 102A and 10213, a modular electric speed controller 104, and a number of modular rail elements 106A, 10613, 106C, 106D, and 106E. It should be understood that the embodiment illustrated is just one example of the swappable modular battery and electronic speed controller system for electric vehicles 100, and the number of modular battery units 102 and modular rail elements 106 may vary. For instance, in some embodiments, the system 100 may only include one modular battery unit. In other embodiments, the system 100 may include a number of modular battery units (2-n). Generally, the number of modular rail elements needed depend on the number of battery units desired.

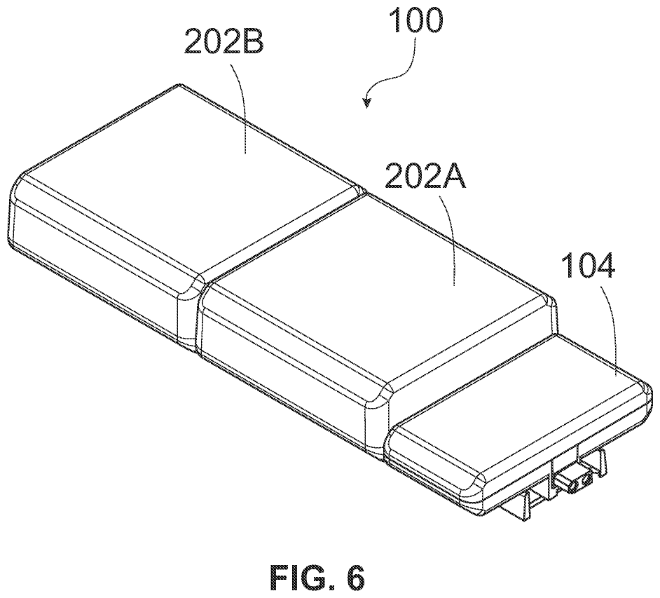

In some embodiments, each modular electric battery unit is a lithium-ion battery. In other embodiments, each modular electric battery unit is a nickel-metal hydride battery. Yet in other embodiments, each modular electric battery unit may be any type of rechargeable battery suitable for powering the various electric vehicles. As is well known in the art, the number of batteries and the power (W) and capacity (Wh) of each battery dictate the overall performance of the vehicle, in terms of power and range respectively. Advantageously, the present invention's system enables a user to add a desired number of modular battery units, each potentially having varied power and/or capacity. For example, in FIG. 6, two larger modular batteries 202A and 202B are shown integrated with swappable modular battery and electronic speed controller system for electric vehicles 100. Likewise, (not pictured), a smaller and larger modular battery may be integrated as well. Various configurations and arrangements are possible.

As known in the art, the electric speed controller (ESC) is configured to serve as the intermediary between the battery and the motor. The ESC regulates the power drawn from the modular battery units and directs it to the motor, effectively controlling the speed of the electric vehicle via a remote, controller, or throttle.

Both the modular batteries and electric speed controller comprises cases that are generally rectangular in shape and constructed of any material or combination of materials suitable for housing battery or ESC components, including but not limited to, plastics, thermoplastics, and metals such as aluminum or stainless steel, as well as composite materials such as fiber composites.

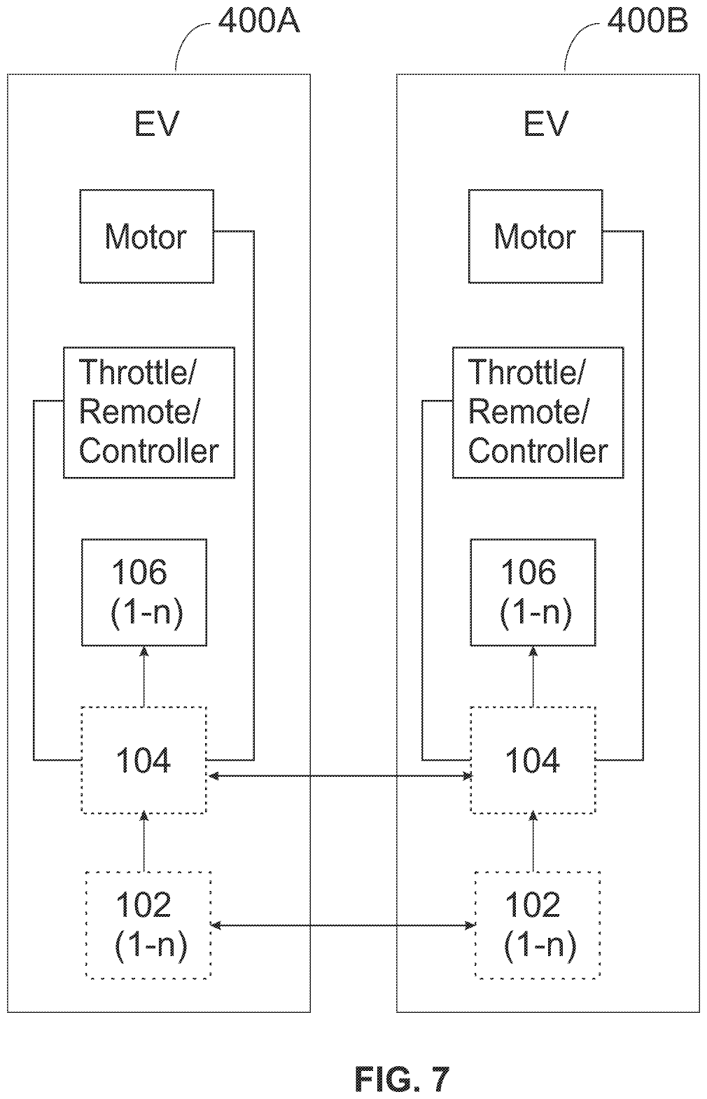

In some embodiments, each modular unit, including the modular battery units 102 and the ESC 104, comprises a protruding housing cavity section 114 configured to house electronic components 108. In other embodiments, the housing cavity section 114 may be integrated into the case such that the housing cavity does not protrude from the bottom portion of the case as illustrated. These components facilitate the connection of each modular component. Specifically, the electronic components 108 comprises an electrical conduit/wiring 110 and terminals 112, wherein the terminals enable the connection between adjacent modular units. The electronic components 108 may further comprise printed circuit boards (PCB) and other necessary components enabling the operation of the system. It should be understood that the swappable modular battery and electronic speed controller system for electric vehicles 100 is a partial system that is configured to integrate with existing electrical components found on each electric vehicle, including but not limited to the motor, the remote, throttle, or control system, and other components necessary for operating the electric vehicle. A schematic diagram of this representation can be seen in FIG. 7. More specifically, referring to FIG. 7, two exemplary electric vehicles 400A and 400B are shown, wherein each electric vehicle may be any type of electric vehicle having a motor and a throttle, remote, or controller. As previously discussed, a plurality of modular rail units 106 (1-n) are attached to the frame or other suitable location on each electric vehicle. As a manner discussed, a modular ESC unit 104 and a number of modular battery units 102 (1-n) are removably attached to the plurality of modular rail units 106. Advantously, the modular ESU unit and any number of modular battery units 102 may be swapped between electric vehicles (represented by the dashed lines and arrows illustrated in FIG. 7). It should be noted for the purpose of this disclosure, these elements, motors, throttles, etc. are outside the scope of the present invention. One skilled in the art would be able to connect the system of the present invention to the electric vehicle, which would involve a connection between the ESC 104 and the motor of one or more electric vehicles 400A-B.

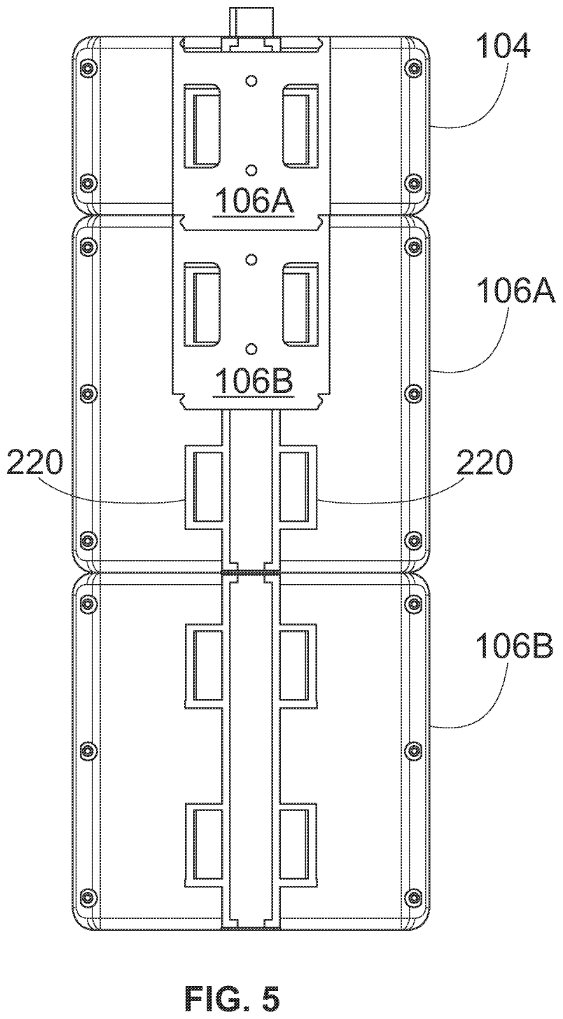

Best seen in FIG. 5, each modular unit, e.g. the modular battery unit 102 and the ESC 104 comprises a pair of attachment guides 220. In one embodiment, each attachment guide 220 extends perpendicularly from housing cavity section 114. It should be understood other structural arrangements are possible, however, the pair of attachment guides 220 should be positioned beneath the case of the modular component to allow the connection and removal of the modular unit within the system. This will be discussed in detail below.

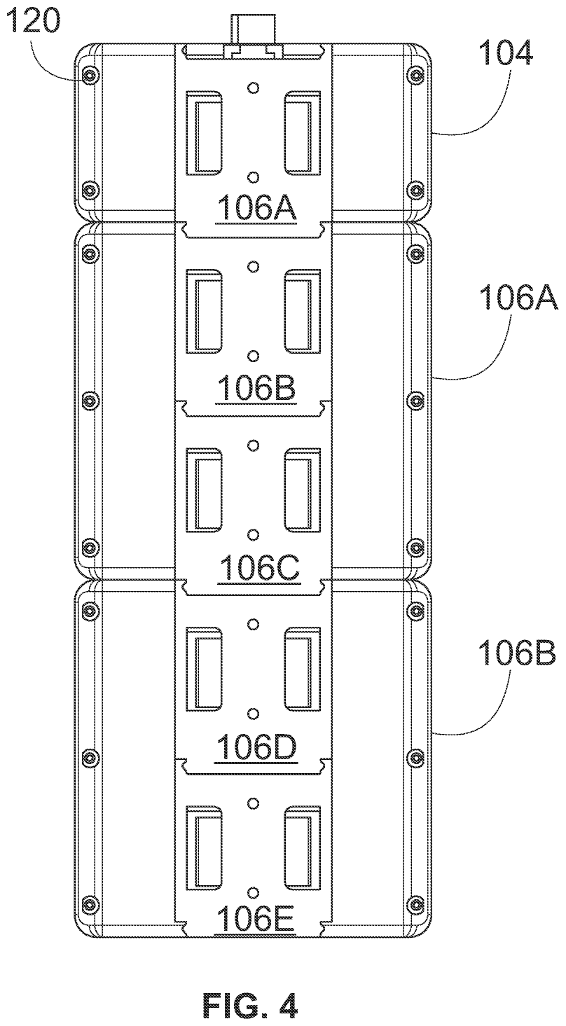

Each modular rail element 106 comprises holes 122, enabling the connection and attachment to the electric vehicle such as on the frame or other suitable location (not illustrated) via fasteners. Each modular rail element is configured to stack horizontally adjacent to another modular rail element (best seen in FIG. 4). In some embodiments, each modular rail element 106 is shaped to nest within an adjacent unit such that the nesting or stacking of adjacent units creates a singular rail element that is seamless between each rail element. In the exemplary illustrated embodiment shown in the drawings, each modular rail element comprises a base 124 having a cavity 126 and extended section 128, wherein the extended section 128 is configured to fit snugly within a cavity 126 of an adjacent rail element. In yet other embodiments, the cavity and extended sections may include corresponding shapes or other elements to assist in lining up and connecting adjacent elements, such that assembling and attaching each rail element to the electrical vehicle is efficient and without errors, and the number of modular rail elements create a seamless singular rail.

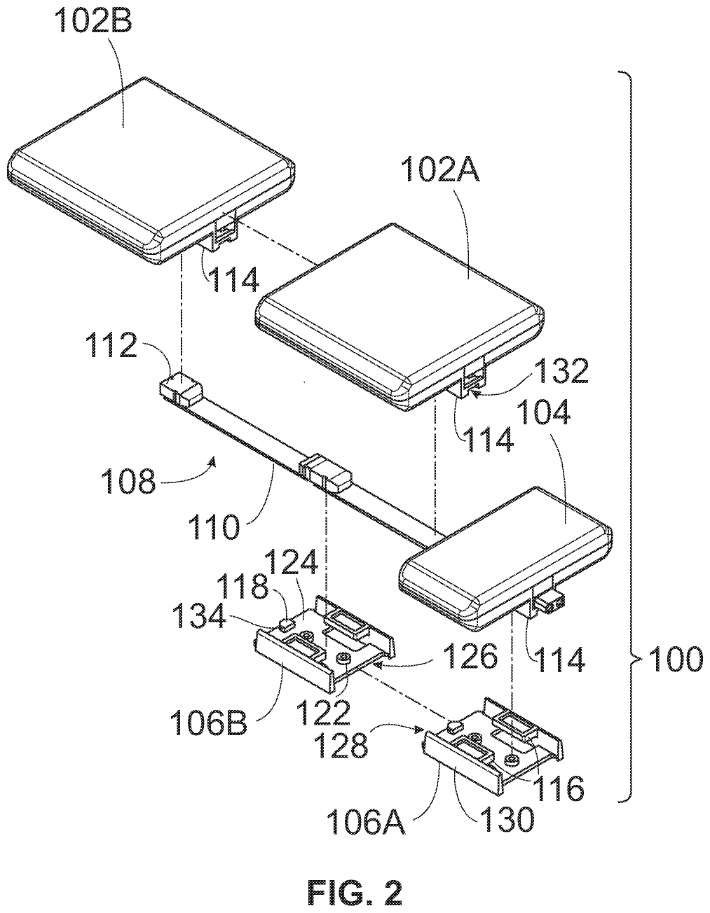

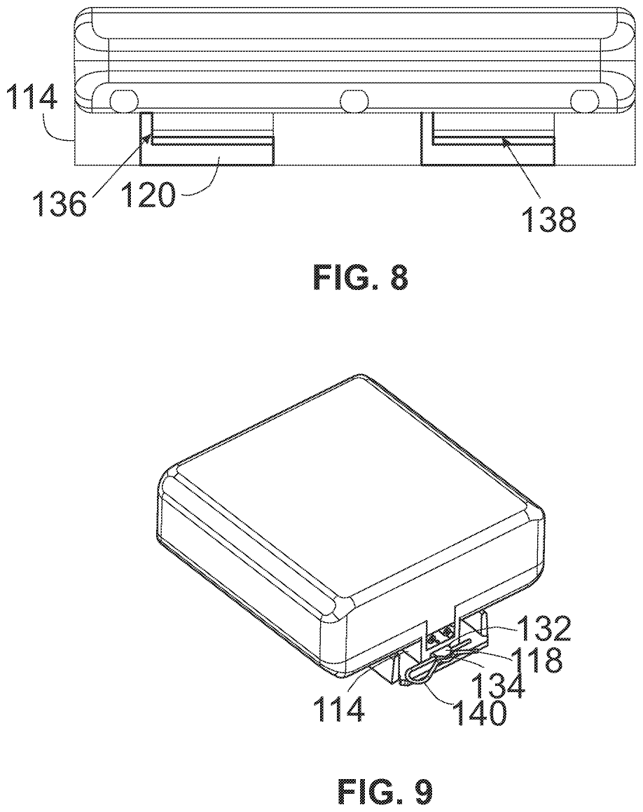

In some embodiments, the modular rail element 106 comprises a pair of vertical walls 130 each having a protruding perpendicular slide attachment element 116. Advantageously, the slide attachment elements 116 are configured to receive the attachment guides 220 of each modular unit. More specifically, the attachment guides are configured to slide under the slide attachment elements. In some embodiments, the positioning of these components provides a frictional engagement or slide fit attachment mechanism that keeps each modular unit positioned within one or more rail elements. In some embodiments, as best seen FIG. 8, each attachment guide 120 comprises a first surface 136 and a second surface 138, wherein the first surface 136 prevents the modular unit from sliding forward as the first surface 136 comes in contact with the front side surface of the slide attachment element (116; FIG. 2). The second surface 138 prevents the modular unit from vertical movement via the bottom surface of the slide attachment element 116.

It should be understood that various attachment mechanisms and technologies may be used to secure each modular unit to the modular rail elements, including but not limited to the use of magnetic connections, tabs, stops, quick release pins, and other removal or temporary attachment or securement methods. In some embodiments, each modular rail element 106 further comprises a securement element 118 positioned at an end or each end of the base. In some embodiments, best seen in FIG. 9, the securement element 118 is configured to fit within or slide within a grove 132 positioned within the case of each modular unit. In some embodiments, an opening 134 may be provided on a side portion of the securement element 118 to enable a pin, such a cotter pin 140 or quick connect pin to provide a stop or wedge preventing the modular units from sliding off the modular rail elements. More specifically, the attachment guides 220 prevent forward movement of each modular unit and the pin 140 prevents backwards movement of each modular unit. In some embodiments, this is a secondary securement feature. In other embodiments, this may be the primary securement feature. Ultimately, it should be appreciated that there are a number of methods to facilitate the securement of the modular units within the rail elements.

The number of rail elements required varies depending on the size of the rail element and the modular battery or ESC case. In the illustrated embodiment, there is one rail element for the ESC and two rail elements for each modular battery unit.

During use, to attach a modular unit, such as a modular battery unit or modular ESC, the user aligns the attachment guides of the modular unit with the slide attachment elements of the modular rail elements. The user then slides the unit along the number of modular rail elements until it is securely positioned. Finally, the user secures all the units using the securement element as previously discussed. The attachment guides, slide attachment elements, and securement element are designed to provide a snug fit, ensuring each modular unit stays in place during use. The electronic components within the unit automatically connect with the system upon attachment, readying the unit for operation.

During use, to remove the one or more modular units, the user simply reverses the attachment process. They disengage the securement element, if present, and then slide the desired number of modular units out from the modular rail elements. The design of the attachment guides and slide attachment elements facilitates this smooth removal. Once removed, the unit's electronic components automatically disconnect from the system. This process allows for quick and easy swapping of units, enabling users to customize their electric vehicle setup or transfer units between different vehicles with minimal effort.

Advantageously, a user may attach multiple modular rail elements to one or more electric vehicles, such as an electric skateboard and an electric bicycle. The position of the modular rail elements is outside the scope of the invention, but as an example, the number of modular rail elements may be attached under the board of the electric skateboard and on the frame of the electric bicycle. Next, the user may slide the modular ESC and one or more modular battery units into the modular rail elements in one vehicle, such as the electric skateboard, in a manner as discussed above, ensuring all electric connections are made.

After use, the user may remove the modular ESC and the one or more modular battery units and transfer and connect these modular components to the modular rail elements positioned on the bicycle frame. Specifically, the electric bicycle can now use the same batteries and ESC that were previously used to power the electric skateboard. As these components are expensive, being able to swap these modular units from one electric vehicle to another saves money while allowing customizable performance. For example, the user may add more modular battery units or replace one sized modular battery units to larger sized modular units to increase the range of the electric vehicle. In other situations, the user may utilize the modular battery units as back-up batteries in case of failure or depleted energy storage. Users may further utilize the swappable modular battery and electronic speed controller system for electric vehicles to avoid travel limitation on electric vehicles, in particular travel limitation on electric batteries. Advantageously, the ability to quickly connect and disconnect the modular ESC and modular battery units from an electric vehicle and swap them to a different electric vehicle is extremely useful. Various non-limiting exemplary use cases are provided below.

In one embodiment, the swappable modular battery and electronic speed controller system for electric vehicles may be utilized by an urban commuter who alternates between an electric scooter for short neighborhood trips and an electric bike for longer commutes or exercise. The modular system facilitates the transfer of the modular battery units and modular ESC from the scooter to the bike, allowing the user to adapt to their daily transportation needs efficiently. In another embodiment, the modular electric vehicle system may be utilized by an outdoor enthusiast who uses an electric skateboard for recreational purposes and an electric boat for fishing or leisure trips. The ability to interchange the battery and ESC between both vehicles provides a cost-effective solution for powering diverse recreational vehicles. In another embodiment, the system may be used by a robotics hobbyist who powers various DIY projects, such as a remote-controlled car or an autonomous robot, with the modular electric vehicle system. The ease of swapping the battery and ESC simplifies the transition between different projects, promoting experimentation and innovation. These embodiments are illustrative and not restrictive. The modular nature of the system provides flexibility for users to adapt it to their specific needs and circumstances, underscoring the broad applicability and innovative potential of the swappable modular battery and electronic speed controller system for electric vehicles, especially with the ability to provide a swappable modular ESC and modular battery units.

Although the invention has been described in considerable detail in language specific to structural features, it is to be understood that the invention defined in the appended claims is not necessarily limited to the specific features described. Rather, the specific features are disclosed as exemplary forms of implementing the claimed invention. In other words, the terminology and phraseology used in this description and the abstract are for illustrative purposes and should not be considered as limiting. In other words, the terminology and phraseology used in this description and the abstract are for illustrative purposes and should not be considered limiting. Therefore, while exemplary illustrative embodiments of the invention have been described, numerous variations and alternative embodiments will occur to those skilled in the art. Such variations and alternative embodiments are contemplated, and can be made without departing from the spirit and scope of the invention.

It should further be noted that throughout the entire disclosure, the labels such as left, right, front, back, top, bottom, forward, reverse, clockwise, counterclockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, references to “first,” “second,” “third,” and so fourth members throughout the disclosure (and in particular, claims) are not used to show a serial or numerical limitation but instead are used to distinguish or identify the various members of the group.

What is claimed is:

1. A swappable modular battery and electronic speed controller system for electric vehicles comprising:
a plurality of modular rail elements configured to attach to an electric vehicle having a motor;
at least one modular battery unit configured to slide into and connect with at least one modular rail element of the plurality of the modular rail elements;
a modular electronic speed controller configured to slide into and connect with at least one modular rail element of the plurality of the modular rail elements, wherein the modular electronic speed controller is configured to regulate power drawn from the at least one modular battery unit and direct it to the motor of the electric vehicle; and,
wherein the at least one modular battery unit and the modular electronic speed controller are removable from the plurality of modular rail elements, allowing for transfer between different electric vehicles.

2. The system of claim 1, wherein the plurality of modular rail elements are configured to stack horizontally adjacent to one another.

3. The system of claim 1, wherein each modular rail element comprises attachment elements and the at least one modular battery unit and the modular electronic speed controller comprise attachment guides configured to slide under the attachment elements.

4. The system of claim 1, wherein the at least one modular battery unit and the modular electronic speed controller comprise a housing configured to house electronic components facilitating the electrical connection of each modular component.

5. The system of claim 4, wherein the electronic components comprises an electrical wiring and terminal connections, wherein the terminal connections enable the electrical connection between adjacent modular units.

6. The system of claim 1, wherein the at least one modular battery unit is a rechargeable battery suitable for powering various electric vehicles.

7. The system of claim 1, wherein the range of the electric vehicle can be adjusted by varying the number of modular battery units.

8. The system of claim 1, wherein the at least one modular battery unit, and the modular electronic speed controller are configured for quick connect and disconnect, facilitating easy swapping of units.

9. The system of claim 1, wherein the at least one modular battery unit, the modular electronic speed controller, and the plurality of modular rail elements are constructed of materials selected from a group consisting of plastics, metals, and composite materials.

10. A swappable modular battery and electronic speed controller system for electric vehicles comprising:
a plurality of modular rail elements configured to attach to one or more electric vehicles, wherein each modular rail element of the plurality of the modular rail elements is configured to stack horizontally adjacent to one another;
at least one rectangular-shaped modular battery unit configured to slide into and connect with at least one modular rail element of the plurality of the modular rail elements;
a rectangular-shaped modular electronic speed controller configured to slide into and connect with at least one modular rail element of the plurality of the modular rail elements, wherein the modular electronic speed controller is configured to regulate power drawn from the at least one modular battery unit and direct it to a motor of the one or more electric vehicle;
wherein the at least one modular battery unit and the modular electronic speed controller are removable from the plurality of modular rail elements, allowing for transfer between each of the one or more electric vehicles; and,
wherein the at least one modular battery unit, and the modular electronic speed controller are configured for quick connect and disconnect, facilitating easy swapping of modular units between each of the one or more electric vehicles.

11. The system of claim 10, further comprising an attachment mechanism configured to secure the at least one modular battery unit and the modular electronic speed controller to the plurality of modular rail elements.

12. The system of claim 10, further comprising a securement element positioned at an end of each modular rail element, configured to prevent the at least one modular battery unit and the modular electronic speed controller from sliding off the modular rail elements.

13. The system of claim 10, wherein each modular rail element is configured to nest within an adjacent modular rail element, creating a seamless singular rail element when stacked horizontally.

14. The system of claim 13, wherein each modular rail element comprises a base having a cavity and an expanded section, the expanded section configured to fit snugly within the cavity of an adjacent modular rail element, facilitating the nesting of adjacent units.

15. The system of claim 11, wherein the attachment mechanism comprises a slide fit attachment mechanism that provides a frictional engagement between the at least one modular battery unit, the modular electronic speed controller, and the plurality of modular rail elements.

16. A swappable modular battery and electronic speed controller system for electric vehicles comprising:
a plurality of modular rail elements configured to attach to one or more electric vehicles, wherein each modular rail element of the plurality of the modular rail elements is configured to nest adjacently, creating a singular seamless rail element;
at least two rectangular shaped modular battery units configured to slide into the singular seamless rail element;
a rectangular-shaped modular electronic speed controller configured to slide into the singular seamless rail element, wherein the modular electronic speed controller is configured to regulate power drawn from the at least one modular battery unit and direct it to a motor of an electric vehicle of the one or more electric vehicles;
wherein at least one of the at least two modular battery units and the modular electronic speed controller are removable from the singular seamless rail element, allowing for transfer between each electric vehicle of the one or more electric vehicles and,
wherein the at least two modular battery units, and the modular electronic speed controller are configured for quick connect and disconnect, facilitating easy swapping of modular units between the one or more electric vehicles.

17. The system of claim 16, further comprising an attachment mechanism configured to secure the at least two modular battery units and the modular electronic speed controller to the plurality of modular rail elements.

18. The system of claim 17, wherein the attachment mechanism comprises a slide fit attachment mechanism that provides a frictional engagement between the at least two modular battery units, the modular electronic speed controller, and the singular seamless rail element.

19. The system of claim 16, further comprising a securement element positioned at an end of each modular rail element, configured to prevent the at least one modular battery unit and the modular electronic speed controller from sliding off the modular rail elements.
